(19) United States
(12) Patent Application Publication
(10) Pub. No.: US 2013/0255414 A1
(43) Pub. Date: Oct. 3, 2013

(54) Parallel Linkage and Actuator Motor Coil Designs for Tube Carrier

(71) Applicants: Matthew Parker-McCormick Bjork, Oakland, CA (US); Michael B. Binnard, Belmont, CA (US); Scott Coakley, Belmont, CA (US)

(72) Inventors: Matthew Parker-McCormick Bjork, Oakland, CA (US); Michael B. Binnard, Belmont, CA (US); Scott Coakley, Belmont, CA (US)

(73) Assignee: Nikon Corporation, Tokyo (JP)

(21) Appl. No.: 13/820,553

(22) PCT Filed: Sep. 8, 2011
(86) PCT No.: PCT/US11/50860

§ 371 Date: Jun. 12, 2013

Related U.S. Application Data
(60) Provisional application No. 61/381,151, filed on Sep. 9, 2010.

(51) Int. Cl. F16H 21/44

(52) U.S. Cl. CPC F16H 21/44
USPC 74/105

(57) ABSTRACT

A stage apparatus includes at least one tube having a first section and a second section, the first section being coupled to a point of reference. The apparatus also includes at least one magnet, a precision stage, and a tube carrier. The precision stage is positioned at least partially over the at least one magnet, and has a first set of coils. The first set of coils cooperates with the at least one magnet to drive the precision stage. The tube carrier is at least partially positioned over the at least one magnet, and includes an end effector portion arranged to carry the second section, wherein the tube carrier further includes a second set of coils, the second set of coils being supported by the end effector portion and arranged to cooperate with the at least one magnet to control motion of the end effector portion.

### CROSS REFERENCE TO RELATED APPLICATION

The present applications claim benefit under 35 U.S.C. §119(e) of U.S. Provisional Patent Application No. 61/381,151, entitled “Parallel Linkage and Actuator Motor Coil Designs for Tube Carrier,” filed Sep. 9, 2010, which is incorporated herein by reference in its entirety.

### BACKGROUND OF THE INVENTION

1. Field of the Invention

The present invention relates generally to equipment used in semiconductor processing. More particularly, the present invention relates to a tube carrier for a stage assembly that includes an end effector and linkage arrangement that supports cables and/or hoses associated with the stage assembly.

2. Description of the Related Art

Actuated motion stages move primarily in one direction of travel with a relatively large range. With regards to other directions, actuated motion stages may have small or near-zero motions. These small or near-zero motions may be controlled or uncontrolled. Cables and hoses associated with a stage that moves primarily in one direction of travel may effectively trail off of the stages in the direction of travel. Such cables and hoses may provide electrical power and cooling or other utilities, respectively, to motion stages.

Often, cables and hoses may have an adverse impact on the operation of a stage. Cables and hoses may cause disturbance forces that affect a stage, and may transmit vibrations to the motion stage. Both disturbance forces and vibrations may have a negative effect on the overall performance of a stage.

When cables and hoses trail off of the back of a stage, any disturbances caused by or transmitted by the cables and hoses may be substantially minimized using cable loops. Cable loops, as will be appreciated by those skilled in the art, are often used to facilitate the movement of cables and hoses which extend between a stage and a fixed ground.

Some motion stages may require large ranges of travel, i.e., significant movement in more than one direction of travel. For example, a planar motor magnetically-levitated wafer stage may have two relatively large ranges of travel, such as travel in an x-direction and a y-direction. Such stages often require multiple cables for actuation power to achieve relatively fast accelerations, and may additionally require cooling hoses to address heat deformations associated with high-power actuators. The cables and hoses often have relatively large inertial masses associated therewith, and may disturb the motion of a stage from a desired trajectory, and may additionally transmit vibrations to the stage. To reduce disturbances on a precision stage associated with the cables and hoses, a secondary tube carrier may be used to carry the cables and hoses with a relatively minimum amount of relative motion between the precision stage and the tube carrier. The tube carrier may carry a significant amount of the inertial masses associated with the cables and hoses and, therefore, reduce the amount of disturbances exerted on the precision stage by the cables and hoses. However, the cables and hoses may exert disturbances on the tube carrier. Further, the costs of implementing a tube carrier may be significant. For example, the footprint of an overall stage apparatus that includes a precision stage and a tube carrier generally increases significantly over a stage apparatus that does not include a tube carrier.

### SUMMARY

The present invention pertains to stage assemblies that include tube carriers having a set of coils arranged to cooperate with a magnet array of a precision planar motor to compensate for disturbances associated with the tubes carried by the tube carriers.

According to one aspect of the present invention, a stage apparatus includes at least one tube, such as an electrical cable or a hose, having a first section coupled to a fixed point of reference, as well as a second section. The stage apparatus also includes a magnet and a tube carrier. The tube carrier includes an end effector portion arranged to carry the second section and is positioned to interact with the magnet, and also includes a set of coils. The set of coils cooperates with the magnet array to drive the tube carrier end effector and to compensate for movement of the tube by controlling the end effector portion. In one embodiment, the tube carrier includes a coupling arrangement that couples the end effector portion to a fixed point of reference. In such an embodiment, the coupling arrangement includes a linkage arrangement that supports movement of the end effector with respect to at least one degree of freedom.

According to another aspect of the present invention, a stage apparatus includes a precision stage arrangement, a precision actuator, and an end effector arrangement. The precision actuator includes a first set of coils coupled to the precision stage arrangement, as well as a magnet array. The magnet array is coupled to a surface over which the precision stage is positioned, and the precision actuator is arranged to impart motion on at least the precision stage arrangement. The end effector arrangement is coupled to the precision stage arrangement and positioned over the surface. The end effector arrangement includes a second set of coils arranged to cooperate with the magnet array to control movement of the end effector arrangement. In one embodiment, the end effector arrangement is configured to carry at least one tube that provides at least one selected from a group including power to the precision stage arrangement and cooling to the precision stage arrangement, and the second set of coils cooperates with the magnet array to compensate for disturbances associated with the tube. In accordance with yet another aspect of the present invention, a method of operating a tube carrier for a precision stage wherein the tube carrier includes an end effector that carries a tube for the precision stage includes activating a precision actuator to cause movement of at least the precision stage. The precision actuator has a first set of coils mounted on the precision stage and a magnet array. The method also includes determining at least one motion of the end effector to be controlled if it is determined that the tube is associated with the disturbance, and determining at least one amount of current to provide to a second set of coils mounted on the end effector to control the motion of the end effector. The second set of coils cooperates with the magnet array to control the end effector. Finally, the method includes providing the current to the second set of coils to control the motion of the end effector and to reduce disturbances on the precision stage. In one embodiment, the second set of coils cooperates with the magnet array to control movement of the end effector in up to approximately six degrees of freedom.

### BRIEF DESCRIPTION OF THE DRAWINGS

The invention will be readily understood by the following detailed description in conjunction with the accompanying drawings, in which:

FIG. 1A is a diagrammatic top-view representation of a stage apparatus that includes a tube carrier and a linkage arrangement in accordance with an embodiment of the present invention.

FIG. 1B is a diagrammatic side-view representation of a stage apparatus, e.g., stage apparatus 100 of FIG. 1A, that includes a tube carrier and a linkage arrangement in accordance with an embodiment of the present invention.

FIG. 2 is a diagrammatic representation of a tube carrier coupled to a coupling arrangement that includes linkage arrangement and an actuator in accordance with an embodiment of the present invention.

FIG. 3 is a diagrammatic representation of a tube carrier coupled to a coupling arrangement that includes a rotational linkage and a linear motor in accordance with an embodiment of the present invention.

FIG. 4A is a diagrammatic representation of a tube carrier coupled to a coupling arrangement that includes a rotary rotational linkage in accordance with an embodiment of the present invention.

FIG. 4B is a diagrammatic representation of a tube carrier coupled to a coupling arrangement that includes a rotational joint and a linear motor in accordance with an embodiment of the present invention.

FIG. 5A is a diagrammatic representation of a tube carrier coupled to a coupling arrangement that includes serial linear motors in accordance with an embodiment of the present invention.

FIG. 5B is a diagrammatic representation of a tube carrier coupled to a coupling arrangement that includes parallel rotary actuators in accordance with an embodiment of the present invention.

FIG. 6A is a diagrammatic representation of an arrangement of coils on a tube carrier that supports motion in approximately five degrees of freedom (DOF) in accordance with an embodiment of the present invention.

FIG. 6B is a diagrammatic representation of a first arrangement of coils on a tube carrier that supports motion in approximately six DOF in accordance with an embodiment of the present invention.

FIG. 6C is a diagrammatic representation of a second arrangement of coils on a tube carrier that supports motion in approximately six DOF in accordance with an embodiment of the present invention.

FIG. 6D is a diagrammatic representation of an arrangement of coils on a tube carrier that supports motion in approximately three DOF in accordance with an embodiment of the present invention.

FIG. 7 is a process flow diagram which illustrates a method of controlling motions associated with an end effector of a tube carrier in accordance with an embodiment of the present invention.

FIG. 8 is a diagrammatic representation of a stage assembly that includes a rotational linkage and a linear motor in accordance with an embodiment of the present invention.

FIG. 9 is a diagrammatic perspective representation of a stage assembly that includes an end effector coupled to serial linear motors in accordance with an embodiment of the present invention.

FIG. 10 is a diagrammatic representation of a photolithography apparatus in accordance with an embodiment of the present invention.

FIG. 11 is a process flow diagram which illustrates the steps associated with fabricating a semiconductor device in accordance with an embodiment of the present invention.

FIG. 12 is a process flow diagram which illustrates the steps associated with processing a wafer, i.e., step 1104 of FIG. 11, in accordance with an embodiment of the present invention.

FIG. 13 is a diagrammatic representation of a twin stage type exposure apparatus in accordance with an embodiment of the present invention.

### DETAILED DESCRIPTION OF THE EMBODIMENTS

Example embodiments are discussed below with reference to the various figures. However, those skilled in the art will readily appreciate that the detailed description given herein with respect to these figures is for explanatory purposes, as the invention extends beyond these embodiments.

Precision motion stages often may utilize numerous cables, e.g., for actuation power in order to achieve relatively fast accelerations, and hoses, e.g., cooling hoses used to address any heat deformations associated with relatively high-power actuators. All of these “tubes,” or cables and hoses, may have relatively large inertial masses associated with them, and may disturb the motion of a precision stage from its intended trajectory. In addition, the cables may also transmit disturbance vibrations to a precision stage. Disturbing the motion of a precision stage and/or transmitting disturbance vibrations to the precision stage may adversely affect the performance of the precision stage.

In some instances, a magnetically-levitated stage with a relatively long stroke in two degrees of freedom (DOF) may utilize a tube carrier, e.g., a substantially separate stage, that carries tubes, e.g., cables and/or hoses, utilized by the magnetically levitated stage. The use of a tube carrier may be effective in reducing disturbances imparted on and/or transmitted to the magnetically levitated stage. However, the use of a tube carrier may have significant costs. For example, the use of a tube carrier for carrying tubes typically results in an enlarged footprint associated with providing a desired operating motion envelope for an overall stage assembly. Additionally, the tube carrier generally requires the same range of motion required by the precision stage, and may have issues with tubes having an adverse effect the range of motion.

A precision motion stage such as a magnetically-levitated stage with one or more DOF may, in one embodiment, have an associated tube carrier with an end effector that cooperates with a linkage arrangement to support tubes utilized by the stage. An overall stage assembly may include the precision motion stage, the tube carrier, and a linkage arrangement that is coupled to a fixed surface such as a ground. The tube carrier and the linkage arrangement cooperate to support the tubes such that any disturbances imparted by and/or transmitted by the tubes to the precision motion stage are substantially minimized. In general, the tube carrier and the linkage arrangement may constrain and control movements of the tubes substantially without applying disturbance forces to the precisions stage. Coils may be carried on the tube carrier, and the coils may support and/or drive the tube carrier by cooperating with a planar magnet array that supports motion of the precision stage. While the tube carrier generally moves with the precision motion stage, coils carried on the tube carrier may effectively provide fine control of motions associated with the tube carrier. In some embodiments, linkage arrangements may include actuators arranged to substantially couple linkages to a fixed surface.

By utilizing a magnet array that is present on a reference surface, e.g., a ground or a countermass, in conjunction with actuator motor coils substantially attached to a surface of a tube carrier, the tube carrier may effectively be supported and/or driven. As such, tubes supported on the tube carrier, and also carried on a linkage arrangement, are supported such that disturbances generated by the tubes may be significantly reduced.

In one embodiment, a precision motion stage may have some areas of travel where tracking accuracy of the stage is not critical. For example, the accuracy of the position of the stage may be less important near a position at which an object such as a semiconductor wafer is loaded and/or unloaded from the stage. Thus, a tube carrier, or end effector, that is part of a stage assembly may be powered when operating within a particular range or area of travel, and may be unpowered when operating within another range or area of travel. When the tube carrier is unpowered, the tube carrier may effectively be dragged by a stage that is included in the stage assembly. While the tube carrier is effectively dragged, disturbances may be imparted on the stage. Such disturbances, however, may generally be an acceptable tradeoff with providing an increased number of planar magnets to support and/or drive the tube carrier.

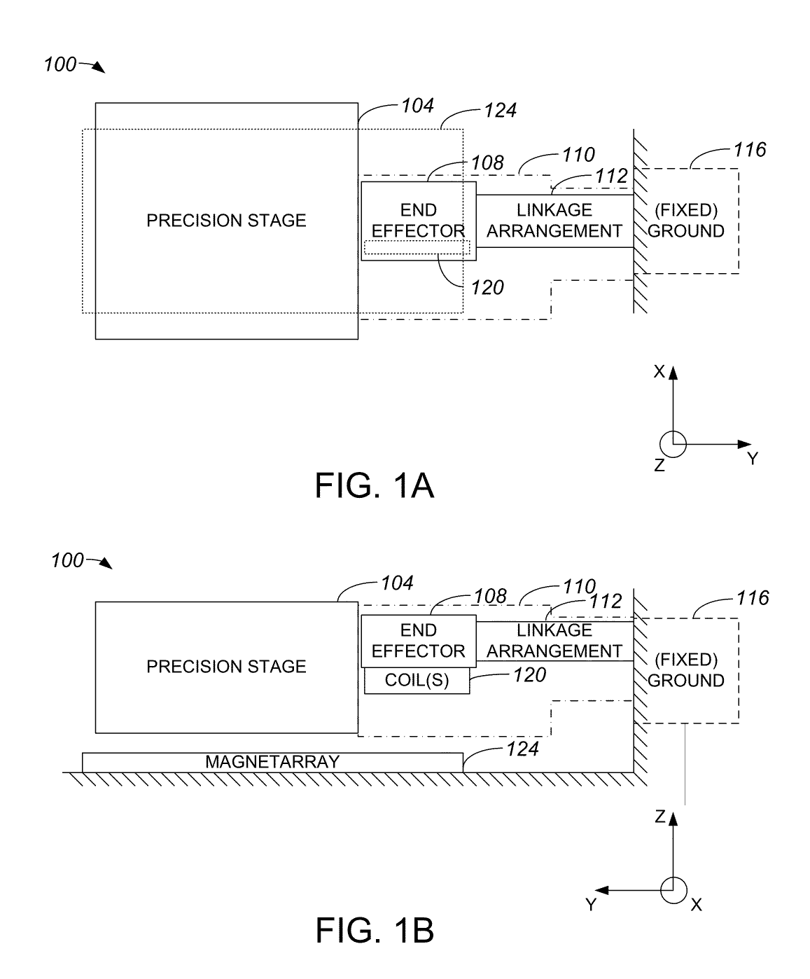

Referring initially to FIGS. 1A and 1B, an overall stage apparatus that includes a tube carrier, or end effector, and a linkage arrangement that cooperate to carry coils will be described in accordance with an embodiment of the present invention. FIG. 1A is a top-view representation of an overall stage apparatus 100, and FIG. 1B is a side-view representation of overall stage apparatus 100. Overall stage apparatus 100 includes a tube carrier 110 that includes an end effector 108 and a linkage arrangement 112. A precision stage 104 may be a magnetically-levitated wafer stage that has one or more DOF, and may be arranged to carry a wafer (not shown) or a reticle (not shown). End effector 108, as shown, is located substantially adjacent to, but is not directly coupled to, a side of precision stage 104. It should be appreciated that end effector 108 is preferably driven to follow the motion of precision stage 104 and maintain a substantially constant position relative to precision stage 104. Depending on the specific design or application, end effector 108 may be positioned substantially adjacent to a top surface or on a bottom surface of precision stage 104.

Tube carrier stage 110 is coupled to a reference surface such as a ground 116 through a linkage arrangement 112. Linkage arrangement 112 may include linkages and joints or, more generally, members. In one embodiment, linkage arrangement 112 may be substantially coupled to ground 116 using actuators (not shown), as will be described below. Linkage arrangement 112 is arranged generally to provide structural support and/or driving force to end effector 108. End effector 108 and linkage arrangement 112 generally constrain and control motions of tubes (not shown) supported by end effector 108 that provide, but are not limited to providing, electrical power, pressurized or compressed air, vacuum, electronic communications, and/or cooling to tube carrier stage 110. Cooling may be provided by water or coolant or, more generally, a liquid. Linkage arrangement 112 may include members that are formed from any relatively stiff, relatively lightweight material. For example, members associated with linkage arrangement 112 may be formed from a carbon fiber composite material. Linkage arrangement 112 may also include a combination of linear or rotary bearings and/or actuators such as rotary or linear motors depending upon, but not limited to depending upon, the specific design and application.

As will be appreciated by those skilled in the art, coils (not shown) mounted underneath precision stage 104 may cooperate with an array of magnets 124, e.g., a planar array of magnets, positioned on ground 116 to allow precision stage 104 to move. In one embodiment, at least one coil 120 is coupled to end effector 108 such that coils 120 cooperate with array of magnets 124 to support and/or drive end effector 108 to follow the motion of precision stage 104 and to reduce the effect on precision stage 104 of disturbances, e.g., drag forces and/or vibrations, associated with tubes (not shown) coupled between tube carrier stage 110 and ground 116. Coils 120 may generally be actuator motor coils, and may operate in cooperation with array of magnets 124 to provide levitation or acceleration forces and/or to dampen and/or augment motions of end effector 108 when end effector 108 moves to follow precision stage 104. The size of coils 120 may vary depending upon a variety of different factors including, but not limited to including, efficiency constraints and space constraints. Larger coils generally operate more efficiently than smaller coils, but typically result in an increase in the overall size of stage assembly 100. Smaller coils utilize less space than larger coils, but are generally more difficult to control. As such, the size of coils 120 may be determined based on trade-offs between the benefits of larger coils and the benefits of smaller coils, as well as the detriments of larger coils and the detriments of smaller coils for a particular application.

The number of coils 120, as well as the orientation of coils 120, may vary based upon the number of DOF that coils 120 are intended to support. Although coils 120 may support and/or control substantially the same DOF as supported by precision stage 104, coils 120 may instead support and/or control fewer DOF than supported by precision stage 104. When coils 120 support and/or control fewer DOF than supported by precision stage 104, linkage arrangement 112 may support and/or control DOF that are not supported by coils 120. In other words, when the DOF supported and/or driven by coils 120 are limited, linkage arrangement 112 may support and/or drive other DOF and, therefore, maintain sufficiently accurate control for the DOF that are not supported and/or driven by coils 120.

Array of magnets 124 is typically sized such that a full range of travel for precision stage 104 may be supported. That is, array of magnets 124 is configured to accommodate substantially all translational and rotational motions that precision stage 104 may undergo. Array of magnets 124 may be a planar magnet array, e.g., a magnet array in an xy-plane, designed for use as part of a precision planar motor that drives precision stage 104. The number of DOF associated with precision stage 104 may vary widely based, for example, on the requirements of overall stage apparatus 100. Precision stage 104 may be actively controlled, in one embodiment, by the planar motor in one, two, three, four, five, or six DOF. In one embodiment, precision stage 104 may be arranged to move with relatively large ranges of travel in two DOF, e.g., an x-direction and along a y-direction.

Coils 120 may be arranged to be active, e.g., current may be provided to coils such that the movement of end effector 108 may be controlled, within a particular range of movement associated with precision stage 104. Conversely, outside of the particular range of movement associated with precision stage 104, coils 120 may be inactive. In one embodiment, coils 120 may be active when the position of coils 120 is substantially directly over array of magnets 124, and coils may be inactive when the position of coils 120 is not substantially directly over array of magnets 124. In other words, while coils 120 are within an operating motion envelope, coils 120 actively support and/or control the motion of end effector 108, and while coils 120 are not within the operating motion envelope and are operating off the edge of array of magnets 124, tubes may effectively be dragged by precision stage 104. It should be appreciated that the operation of coils 120 off the edge of array of magnets 124 may correspond to a travel range of precision stage 104 within which the accuracy with which precision stage 104 operates is less critical.

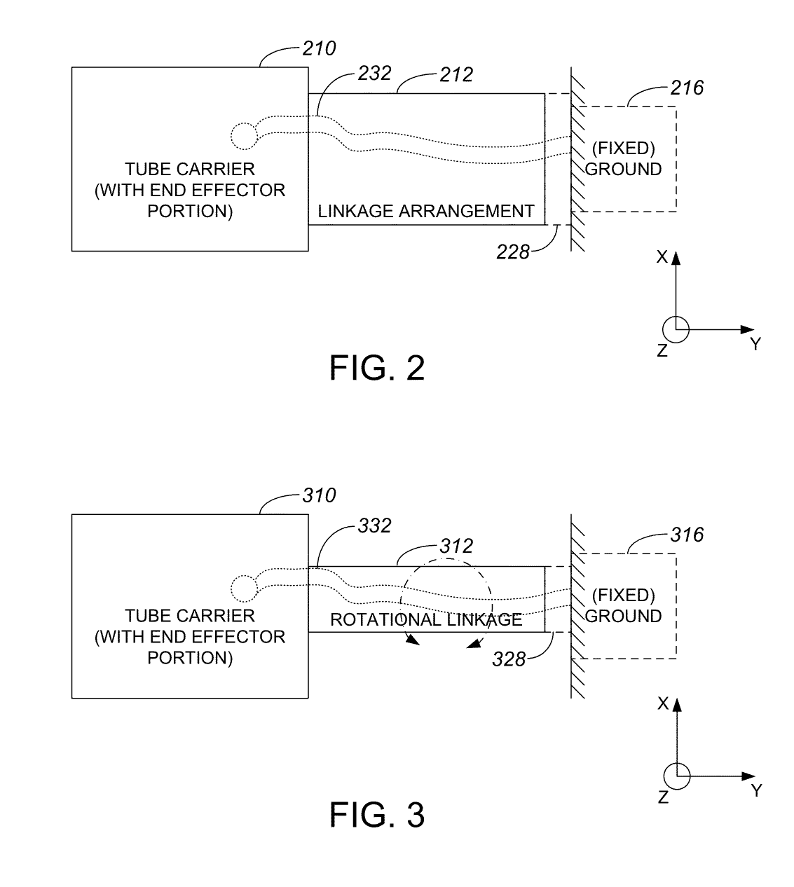

As mentioned above, a linkage arrangement 112 may effectively be coupled to ground 116 through an actuator (not shown). That is, an interface between linkage arrangement 112 and ground 116 may include at least one actuator (not shown). Thus, an overall coupling arrangement between tube carrier stage 110 and ground 116 may include linkage arrangement 112 and at least one actuator (not shown). FIG. 2 is a diagrammatic representation of a tube carrier coupled to a coupling arrangement that includes linkage arrangement and an actuator in accordance with an embodiment of the present invention. A tube carrier 210, which typically includes an end effector portion and a linkage arrangement 212. Tubes 232 are carried on tube carrier 210 to provide power, communication, and/or utilities to a precisions stage (not shown). As shown, tubes 232 are coupled to a ground 216, or a fixed point of reference. Those skilled in the art will understand that ground 216 shown in this and other embodiments may be a fixed ground such as a machine frame or floor, or a moving countermass that absorbs reaction forces from a stage and/or tube carrier 210. That is, ground 216 may be a countermass.

As shown, linkage arrangement 212 is coupled to ground 216 through an interface 228. Interface 228 may include at least one actuator that is arranged to support movement of linkage arrangement 212. Actuators included in interface 228 may be, but are not limited to being, linear actuators and/or rotary actuators. It should be appreciated that although linkage arrangement 212 is shown as being coupled to ground 216 through interface 228, linkage arrangement 212 may also be coupled to ground 216.

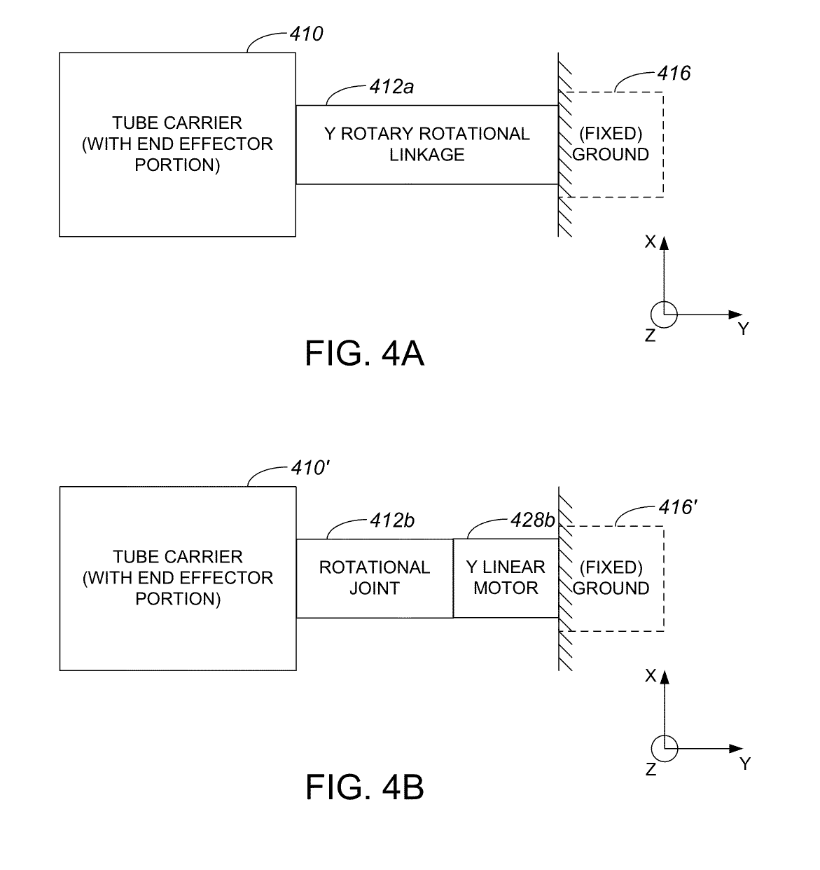

In one embodiment, a linkage arrangement may be a rotational linkage, and a linear motor may effectively couple the rotational linkage to a fixed point of reference. FIG. 3 is a diagrammatic representation of a tube carrier coupled to a coupling arrangement that includes a rotational linkage and a linear motor in accordance with an embodiment of the present invention. A tube carrier 310 is coupled to a ground 316, e.g., a countermass or a balance mass, through a coupling arrangement that includes a rotational linkage 312 and a linear motor 328. Tubes 332 are carried by tube carrier 310, typically on an end effector portion of tube carrier 310 and supported along appropriate portions of rotational linkage 312 and linear motor 328. As shown, tubes 332 are coupled to ground 316.

Rotational linkage 312 may rotate about a z-axis. Linear motor 328 may provide translational motion to rotational linkage 312, and to an end effector portion of tube carrier stage 310, along a y-axis. In the described embodiment, linear motor 328 may provide the end effector portion of tube carrier 310 with movement along a y-axis, while coils (not shown) associated with the end effector portion provide movement along an x-axis.

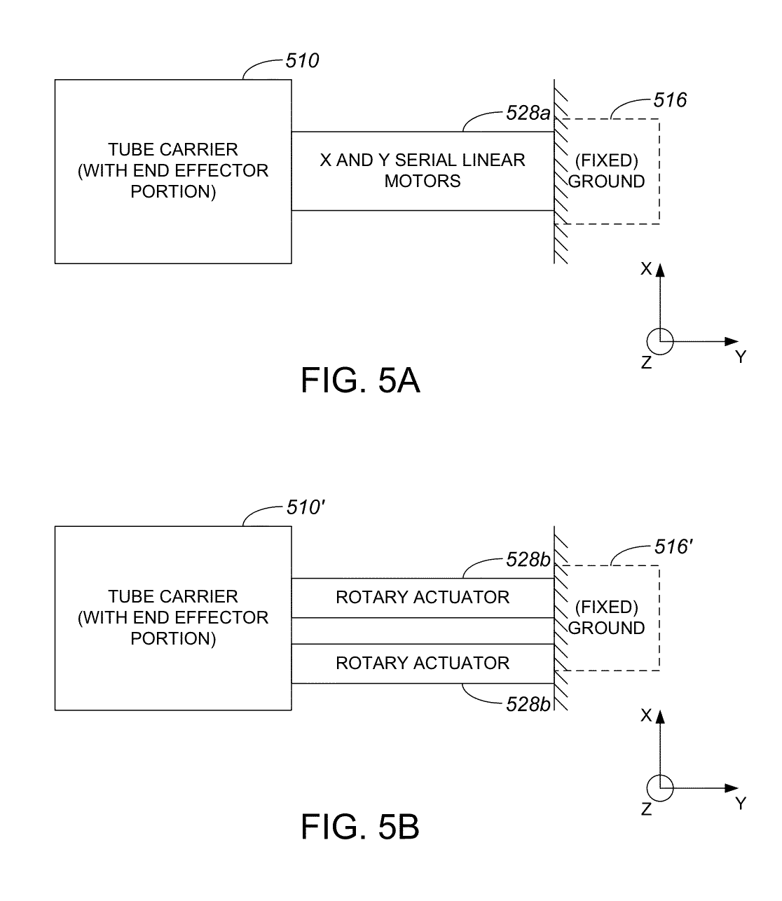

A coupling arrangement that couples a tube carrier to a ground may include a linkage arrangement that provides rotational motion. With reference to FIG. 4A, one tube carrier coupled to a coupling arrangement that provides rotational motion will be described in accordance with an embodiment of the present invention. A tube carrier 410 is coupled to a ground 416 through a coupling arrangement that includes a linkage that includes arms and an “elbow” joint, e.g., a rotary rotational linkage 412a, which are driven by one or more rotary motors. Tubes (not shown) are carried by an end effector portion of tube carrier 410 and are coupled to ground 416. As shown, rotary rotational linkage 412a is substantially directly coupled to ground 416, and is not coupled to ground 416 through any actuator.

In the described embodiment, coils (not shown) associated with the end effector portion of tube carrier 410 may prove translational force along an x-axis. Thus, motion relative to a y-axis is supported by rotary rotational linkage 412, and motion along an x-axis is supported by coils (not shown) associated with an end effector of tube carrier stage 410.

Referring next to FIG. 4B, a second tube carrier coupled to a coupling arrangement that provides rotational motion will be described in accordance with an embodiment of the present invention. A tube carrier stage 410′ is coupled to a ground 416′ through a coupling arrangement that includes a rotational joint 412b and a Y linear motor 428b. Tubes (not shown) are carried by an end effector portion of tube carrier stage 410′ and are coupled to ground 416′. It should be appreciated that although Y linear motor 428b is shown as being coupled to ground 416′, rotational joint 412b may instead, or additionally, be coupled to ground 416′.

Rotational joint 412b supports rotational motion about up to three axes. That is, rotational joint 412b may support rotation about an x-axis, a y-axis, and/or a z-axis. It should be appreciated that rotational joint 412b may be associated with at least one particular axis of rotation. Y linear motor 428b is configured to provide force along a y-axis. As such, rotational joint 412b and Y linear motor 428b generally cooperate to provide an end effector portion of tube carrier stage 410′ with movement along a y-axis, as well as about an x-axis, the y-axis, and/or a z-axis. Movement of the end effector portion of tube carrier stage 410′ along an x-axis is supported by coils (not shown) positioned substantially under the end effector portion. In one embodiment, a gantry arrangement may facilitate movement of Y linear motor 410′ along an x-axis. A gantry arrangement may be an H-shaped arrangement of stacked linear motors, as for example an arrangement in which a Y linear motor may be moved by two X linear motors or an arrangement in which an X linear motor may be moved by two Y linear motors.

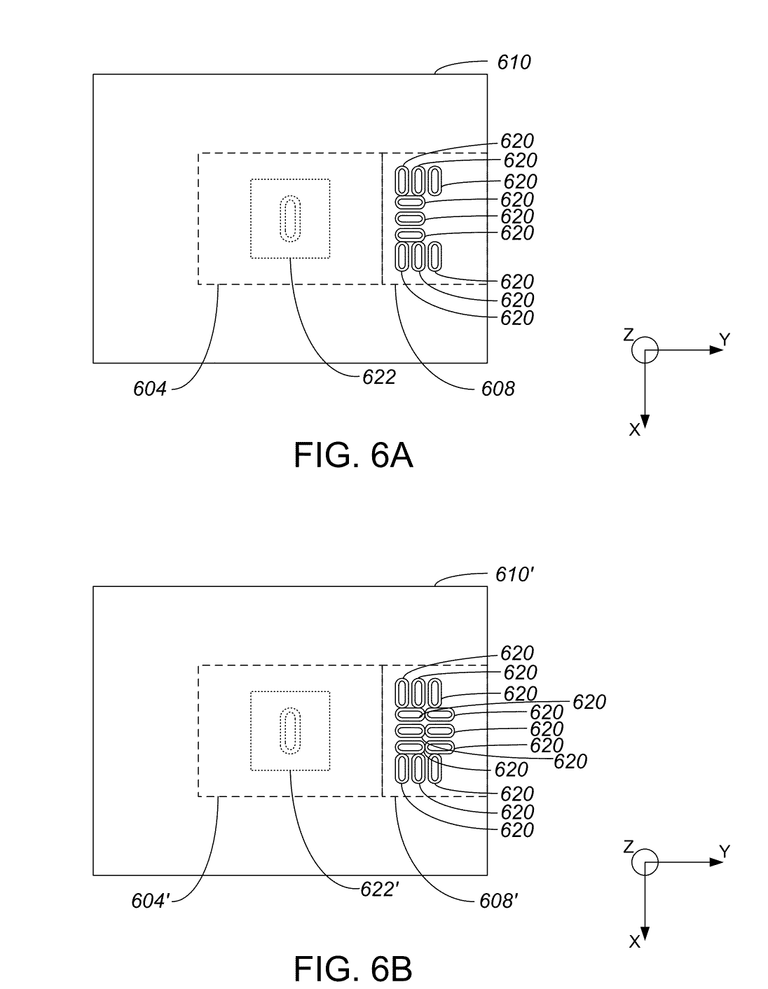

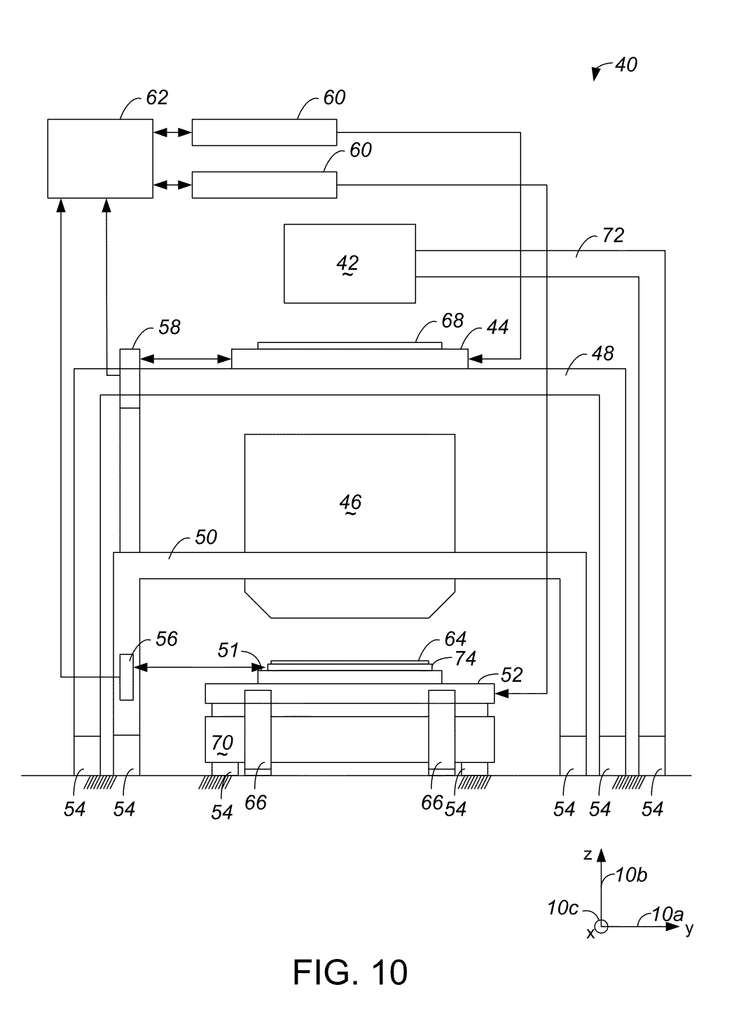

In some situations, coils may be provided on an end effector portion of a tube carrier stage predominantly for purposes of reducing the transmission of vibrations or other disturbances through tubes. That is, coils provided on an end effector portion may be utilized primarily to provide fine control to decrease disturbances, and not to provide relatively large accelerating forces or coarse control to the end effector portion. When coils associated with an end effector portion are arranged primarily to decrease disturbances, dedicated actuators may provide acceleration force to the end effector portion. FIG. 5A is a diagrammatic representation of a tube carrier, e.g., a tube carrier with an end effector portion that accommodates planar coils to decrease vibrations associated with tubes, coupled to a coupling arrangement that includes serial linear motors, as in a gantry system, in accordance with an embodiment of the present invention. A tube carrier 510 includes a precision stage portion and an end effector portion. The end effector portion of tube carrier stage 510 is coupled to a ground 516, or a countermass, using a plurality of linear motors 528a. In the described embodiment, linear motors 528a include an X linear motor and a Y linear motor that have a serial configuration. The X linear motor supports the movement of the end effector portion with respect to an x-axis, and the Y linear motor supports the movement of the end effector portion with respect to a y-axis. One example of tube carrier stage 510 will be described below with reference to FIG. 10.

FIG. 5B is a diagrammatic representation of a tube carrier, e.g., a tube carrier with an end effector portion that accommodates planar motor coils to decrease vibrations and/or other disturbances associated with tubes, coupled to a coupling arrangement that includes parallel rotary actuators in accordance with an embodiment of the present invention. A tube carrier stage includes an end effector portion arranged to be controlled to follow the motion of a precision stage (not shown). The end effector portion of tube carrier 510′ is coupled to a ground 516′ or a countermass using a plurality of rotary actuators 528b. As shown, rotary actuators 528b have a parallel configuration. Each of the plurality of rotary actuators 528b is arranged to provide a controllable moment about a z-axis, and to substantially resist rotation about both an x-axis and a y-axis. The plurality of rotary actuators 528b may include linkages (not shown) which allow the end effector portion of tube carrier 510′ to move along an x-axis and a y-axis. It should be appreciated that in lieu of utilizing a plurality of rotary actuators 528b operating in parallel, a single rotary actuator may instead be coupled to the end effector portion of tube carrier stage 510′.

The kinematics associated with linkages may be arranged to control or constrain substantially all or a subset of X, Y, Z, rotation about an x-axis (Θx), rotation about a y-axis (Θy), and rotation about a z-axis (Θz) motions of the end effector of a tube carrier. For example, where desired Θz motions are zero, or approximately zero, a linkage that includes passive bearings may be implemented to substantially constrain Θz to be zero or approximately zero. Thus, as few as two actuators may be used to control X and Y motions.

The geometry choice of rotary or linear actuators, arm lengths, and parallel-linkages is dependent, at least in part, upon the desired stiffness of the end-effector and its range of motion. It should be appreciated that in the case of a lithography stage, the total range of stage motion may depend on various factors such as wafer size, the size of an exposure site, and the location of load/unload locations.

As previously mentioned, a planar magnet array, e.g., array of magnets 124 of FIGS. 1A and 1B, designed for a precision planar motor that drives a precision motion stage cooperates in one embodiment with coils associated with an end effector, e.g., coils 120 of FIGS. 1A and 1B, to effectively create a tube carrier capable of motion in up to six DOF. Coils associated with a tube carrier end effector may be smaller coils, and may be a smaller set than a set of coils used to drive a precision motion stage associated with the end effector. The smaller set of coils may be used to control at least some of up to six DOF associated with the end effector, while additional degrees of freedom controlled by linkages and/or separate actuators, as discussed above. In one embodiment, coils associated with an end effector may be inactive and tubes carried by the end effector may effectively be dragged when operating in areas where a precision motion stage has reduced positional requirements. In another embodiment, coils associated with an end effector may be used to dampen and/or augment the motions of an externally driven end effector.

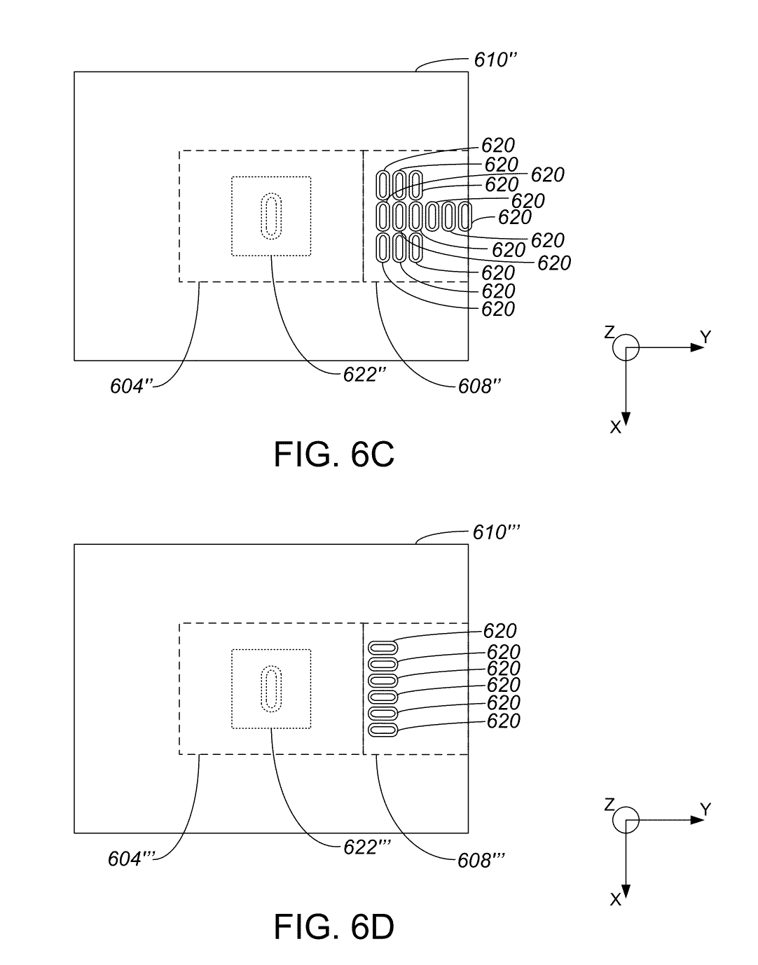

The orientation of coils associated with an end effector may vary widely based upon a number of factors including, but not limited to including, the number of DOF to be controlled and/or the range of travel over which the end effector is to be controlled. In general, an increase in a number of DOF to be controlled results in an increase in a number of coils. With reference to FIG. 6A, an arrangement of coils on an end effector portion of a tube carrier that supports motion in approximately five DOF in accordance will be described with an embodiment of the present invention. A tube carrier 610 that is part of an overall stage apparatus includes an end effector portion 608 which is controlled such that end effector portion 608 follows the motion of a precision motion stage portion 604. A first set of coils 622, which is illustrated as a single coil for ease of illustration, is arranged to cooperate with an array of magnets (not shown), e.g., a planar magnet array that is arranged on a surface of the overall stage apparatus, to drive precision motion stage portion 604. The first set of coils 622 and the array of magnets (not shown) are part of a precision actuator. A second set of coils 620 is arranged to cooperate with the array of magnets (not shown) to substantially control up to approximately five DOF of end effector portion 608. It should be appreciated that the first set of coils 622 and the second set of coils 620 are typically independently activated.

In the embodiment as shown in FIG. 6A, the second set of coils 620 includes nine coils 620, and is arranged to control any or all of X, Y, Z, Θy, and Θz motions of end effector portion 608. As shown, coils 620 are arranged in three groups, each with three coils which act as a three-phase motor capable of generating controlled force in a Z direction and either an X or Y direction. It should be appreciated that, in general, at least three coils are arrayed substantially side-by-side along a y-axis and may provide acceleration force along the y-axis and a vertical force along the z-axis. Furthermore, a group of three coils arrayed substantially side-by-side along the x-axis may provide acceleration force along the x-axis and a vertical force along the z-axis. The nine coils shown in FIG. 6A may produce up to three independently controlled forces in the Z direction, up to two independently controlled forces in the Y direction, and one independently controlled force in the X direction.

In another embodiment, control of up to six DOF of an end effector may be beneficial. That is, control of any or all of X, Y, Z, Θx, Θy, and Θz motions of an end effector portion may be desired. FIG. 6B is a diagrammatic representation of a first arrangement of coils on a tube carrier stage that supports motion in up to six DOF in accordance with an embodiment of the present invention, and FIG. 6C is a diagrammatic representation of a second arrangement of coils on a tube carrier stage that supports motion in up to six DOF in accordance with an embodiment of the present invention.

As shown in FIG. 6B, a tube carrier 610′ that is part of an overall stage apparatus includes an end effector portion 608′ arranged to be controlled to follow the motion of a precision motion stage portion 604′. A first set of coils 622′, shown as a single coil for ease of illustration, is arranged to cooperate with an array of magnets (not shown) to drive tube carrier stage 610′, and a second set of coils, which is comprised of coils 620′, is arranged to cooperate with the same array of magnets to substantially control up to six DOF of end effector portion 608′. It should be appreciated that the first set of coils 622′ and the array of magnets (not shown) generally form a precision actuator that allows precision motion stage portion 604′ to move in up to six DOF.

The second set of coils includes twelve coils 620′, and is arranged to control any or all of X, Y, Z, Θx, Θy, and Θz motions of end effector portion 608′. In contrast to the embodiment shown in FIG. 6A, the embodiment of FIG. 6B includes three additional coils for generating controlled Y and Z force. The additional coil group formed from the three additional coils is spaced apart from the first Y coil group in the Y direction to allow control of a Θx moment by creating differential Z forces.

A tube carrier stage 610″, as shown in FIG. 6C, includes an end effector portion 608″ that carries twelve coils 620″ and which is controlled to follow the motion of a precision motion stage portion 604″. A first set of coils 622″, which is shown as a single coil for ease of illustration, is mounted on precision stage portion 604″, and is arranged to cooperate with an array of magnets (not shown) to form a precision motion actuator to drive precision motion stage portion 604″. A second set of coils which comprises coils 620″ is mounted on end effector portion 608″, and is arranged to cooperate with the array of magnets (not shown) of the precision motion actuator to substantially control up to six DOF of end effector portion 608″. Coils 620″ are arranged to control any or all of X, Y, Z, Θx, Θy, and Θz motions of end effector portion 608″. In contrast to the embodiment shown in FIG. 6A, additional coils 620″ arrayed along a y-axis may provide Θx moment. In some instances, a tube carrier may include limited space in which coils may be placed, and/or the number of DOF of an end effector that are to be controlled may be such that a reduced number of coils may be utilized. FIG. 6D is a diagrammatic representation of a set of coils associated with an end effector of a tube carrier that provides controlled force/moment in up to three DOF in accordance with an embodiment of the present invention. A tube carrier stage 610′″ includes an end effector portion 608′″ which is controlled to follow the motion of a precision motion stage portion 604′″. A first set of coils 622′″, which is shown as a single coil for ease of illustration, is arranged to cooperate with an array of magnets (not shown) to form a precision actuator that drives tube carrier stage 610′″. A second set of coils which comprises coils 620′″ includes six coils 620′″, and is arranged to cooperate with the array of magnets (not shown) to substantially control up to three DOF of end effector portion 608′″. Coils 620′″ are arranged to control any or all of X, Z, and Θy motions of end effector portion 608′″.

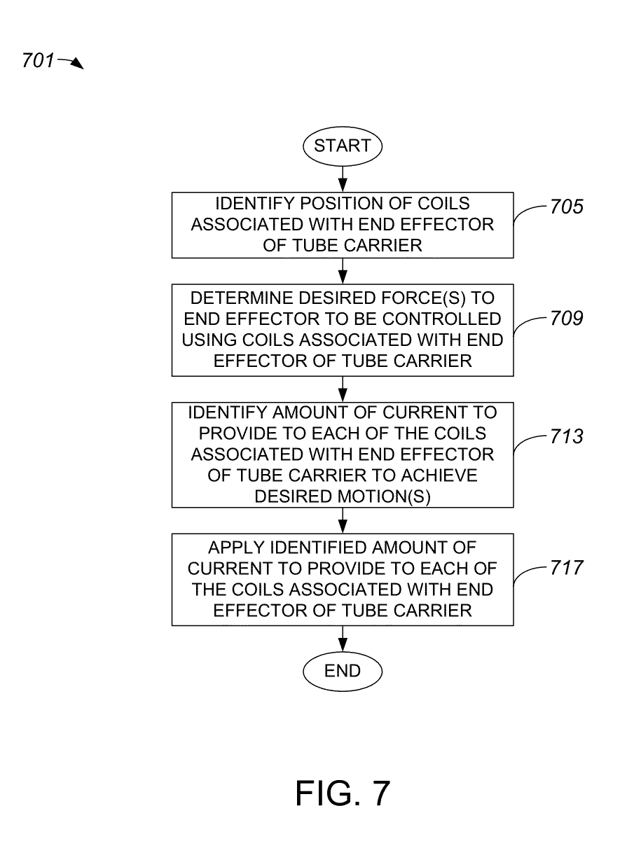

With reference to FIG. 7, one method of controlling motions associated with an end effector of a tube carrier stage will be described in accordance with an embodiment of the present invention. As will be appreciated by those skilled in the art, a controller associated with an overall stage assembly that includes the tube carrier stage may control the motions of an end effector of the tube carrier stage. A method 701 of controlling motions associated with an end effector of a tube carrier stage begins at step 705 in which a position of coils associated with the end effector is identified. The position of the coils associated with the end effector generally indicates the relationship of the coils and the magnet array and thereby how to provide current to the coils, known in the art as commutation, to create a desired force.

Once the position, e.g., commutation position, of coils associated with the end effector is identified, at least desired force to apply to the end effector that is to be controlled using the coils associated with the end effector is determined in step 709. In one embodiment, determining desired forces to be controlled may be based at least in part upon information relating to the overall movement of a precision stage and the tube carrier, as well as any disturbances associated with tubes that are carried by the end effector or linkage arrangement. For example, determining motions to be controlled may include identifying a desired or required acceleration of the tube carrier and/or disturbances which may be acting on a precision motion stage included in the stage assembly.

After at least one desired force that is to be controlled using the coils associated with the end effector is determined, an amount of current to provide to each of the coils is identified in step 713. The amount of current to provide to each coil is calculated based, at least in part, on the commutation position of the coils relative to the magnet array and on an amount of desired force needed to achieve desired motions of the end effector. The identified amount of current is applied, or otherwise provided, to the coils associated with the end effector in step 717, and the method of controlling motions of the end effector is completed.

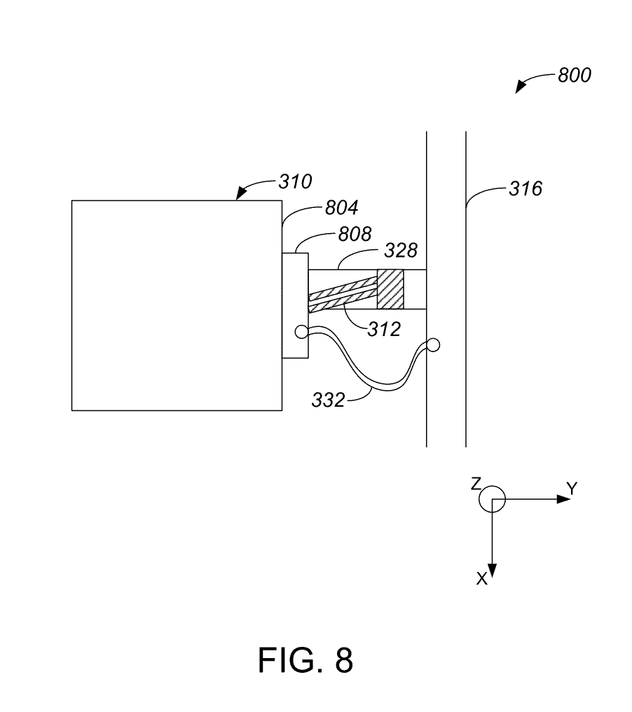

FIG. 8 is a diagrammatic representation of a stage assembly that includes a tube carrier, e.g., tube carrier 310 of FIG. 3, having rotational linkage and a linear motor in accordance with an embodiment of the present invention. An overall stage apparatus 800 includes a precision motion stage 804 and tube carrier 310 having an end effector portion 808. End effector portion 808 carries or supports one section of tubes 332, while another section of tubes 332 is coupled to a fixed point of reference, e.g., a ground or countermass 316. End effector portion 808 is also coupled to a coupling arrangement that includes a rotational linkage 312 and a linear motor 328 that provides motion along a y-axis. Rotational linkage 312 and linear motor 328 are coupled at both end effector 808 and ground 316.

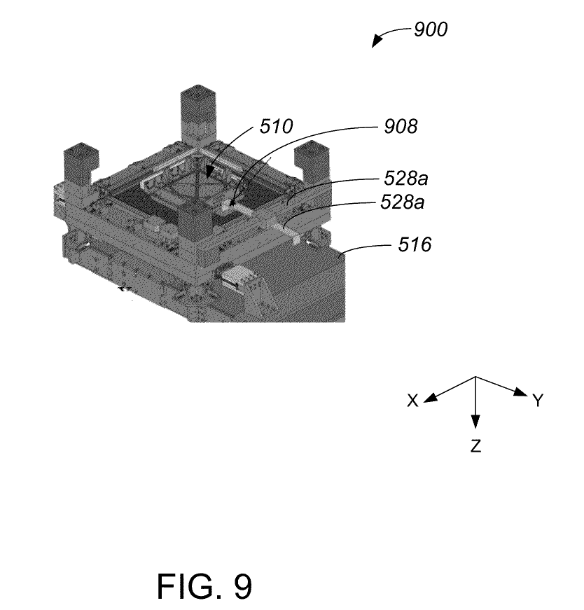

In general, coils mounted on an end effector may cooperate with a magnet array, e.g., a magnet array associated with a precision actuator that drives a precision motion stage, may allow for improving the stiffness of the control system for the end effector in contrast to a system where all of the actuation is provided at the other end of the linkage arrangement. For example, coils mounted on an end effector may be able to more accurately control the end effector position along an x-axis and a z-axis. FIG. 9 is a perspective representation of a stage assembly that includes a tube carrier, e.g., tube carrier 510 of FIG. 5A, having an end effector coupled to serial linear motors in accordance with an embodiment of the present invention. An overall stage assembly 900 includes a precision motion stage and a tube carrier 510 that includes an end effector 908. End effector 908 is coupled to a fixed point of reference, e.g., a ground or countermass 516, through linear motors 528a. In the described embodiment, linear motors 528a include an X linear motor and a Y linear motor. Typically each linear motor 528a works in conjunction with an associated linear guide bearing (not shown), which may be an air bearing or a roller bearing.

Coils (not shown) mounted on end effector 908 may control motion of end effector 908 relative to a z-axis such that the stiffness in the Z direction of linkages or the linear bearings associated with linear motors 528a may be relatively low. Such coils (not shown) may also be used to exert some forces along an x-axis, and may further damp out oscillatory motions of linkages or rails associated with linear motors 528a, thereby allowing the linkages or rails to be relatively lightweight. It should be appreciated that end effector 908 may also be relatively lightweight when coils (not shown) damp out oscillatory motions.

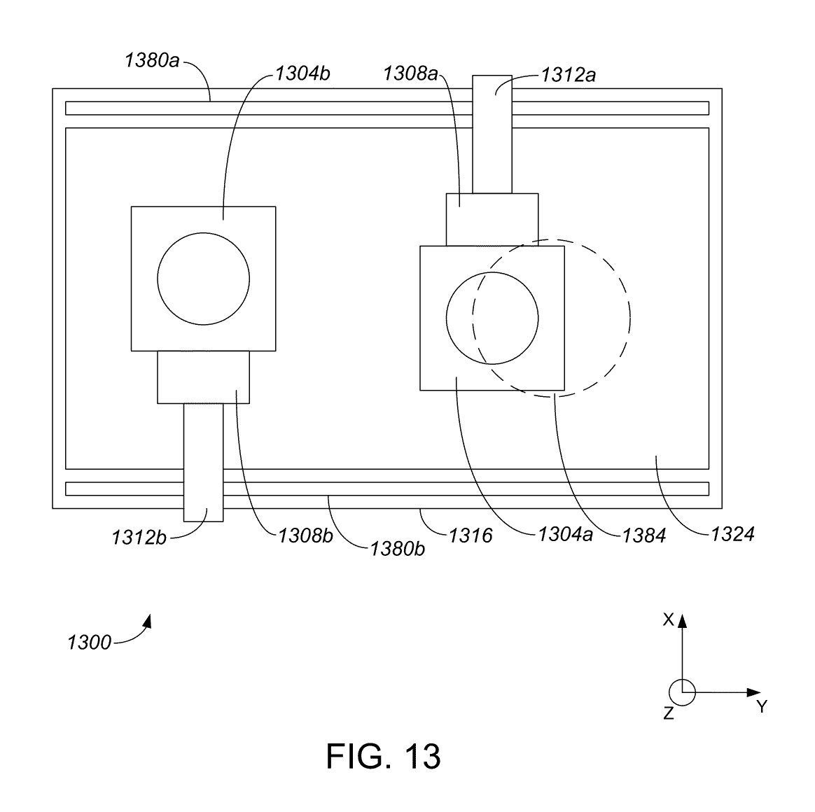

A stage apparatus that utilizes an end effector and a linkage arrangement that cooperate to carry coils may be associated with a twin stage type exposure apparatus. FIG. 13 is a diagrammatic representation of a twin stage type exposure apparatus in accordance with an embodiment of the present invention. An exposure apparatus 1300 includes precision stages 1304a, 1304b. Precision stages 1304a, 1304b may be magnetically-levitated stages that have one or more DOF, and may each be arranged to carry a wafer (not shown) or a reticle (not shown). An optical system 1384 is generally arranged over precision stages 1304, 1304b relative to a z-axis.

Each precision stage 1304a, 1304b has an associated, adjacently located, end effector 1308a, 1308b, respectively, on which coils (not shown) are mounted. In one embodiment, end effectors 1308a, 1308b support tubes. Coils (not shown) mounted on end effectors 1308a, 1308b cooperate with an underlying magnet array 1324 to drive end effector 1308a to follow the motion of precision stage 1304a and to maintain a substantially constant position relative to precision stage 1304a, as well as to drive end effector 1308b to follow the motion of precision stage 1304b and to maintain a substantially constant position relative to precision stage 1304b. Magnet array 1324 is generally arranged to function as a stator of a planar motor that drives precision stages 1304a, 1304b.

Each end effector 1308a, 1308b is coupled to a linkage arrangement 1312a, 1312b, respectively. Linkage arrangements 1312a, 1312b may include any number of members, and may also include actuators and/or bearings. Linkage arrangement 1312a is coupled to an actuator 1380a that provides motion with respect to a y-axis, and linkage arrangement 1312b is coupled to an actuator 1380b that provides motion with respect to the y-axis. As shown, linkage arrangements 1312a, 1312b are effectively coupled to a base 1324, e.g., a ground, through actuators 1380a, 1380b, respectively.

With reference to FIG. 10, a photolithography apparatus which may use the linkage designs and/or the actuator motor coil designs discussed above will be described in accordance with an embodiment. A photolithography apparatus (exposure apparatus) 40 includes a wafer positioning stage 52 that may be driven by a planar motor (not shown), as well as a wafer table 51. The planar motor which drives wafer positioning stage 52 generally uses an electromagnetic force generated by magnets and corresponding armature coils arranged in two dimensions.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In one described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties. In preferred embodiments, base 70 acts as a countermass absorbing the reaction force from the positioning stage 52.

An illumination system 42 is supported by a frame 72. Frame 72 is supported to the ground via isolators 54. Illumination system 42 includes an illumination source, which may provide a beam of light that may be reflected off of a reticle. In one embodiment, illumination system 42 may be arranged to project a radiant energy, e.g., light, through a mask pattern on a reticle 68 that is supported by and scanned using a reticle stage 44 which includes a coarse stage and a fine stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. A second interferometer 58 is supported on projection optical system 46, and detects the position of reticle stage 44 which supports a reticle 68. Interferometer 58 also outputs position information to system controller 62. In some embodiments additional interferometer or other sensors, such as position encoders, may be used to monitor the position of the wafer table 51 relative to the projection optics frame 50.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave minor. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave minor, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

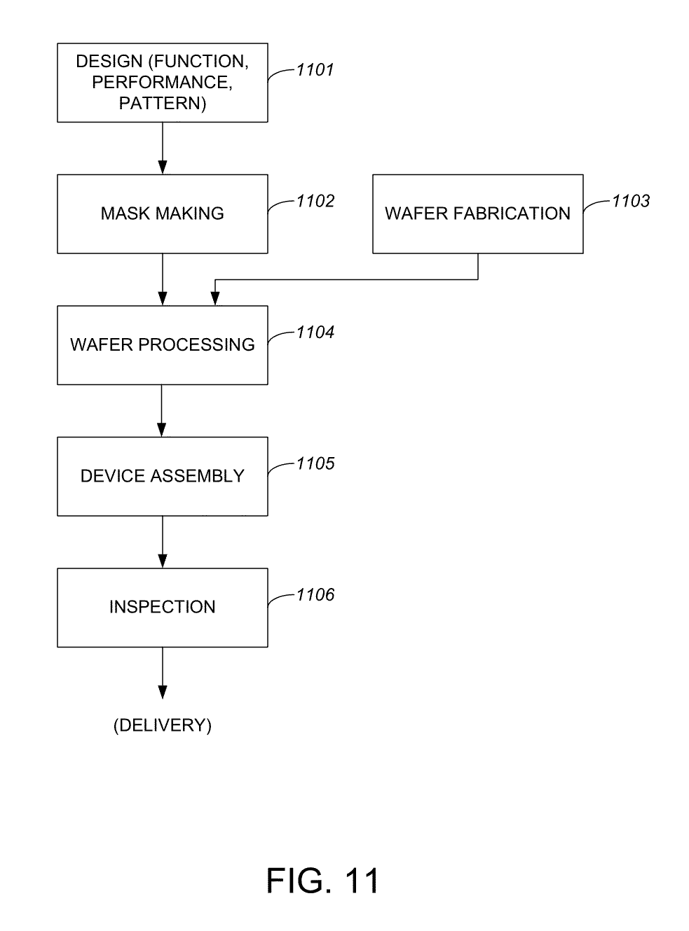

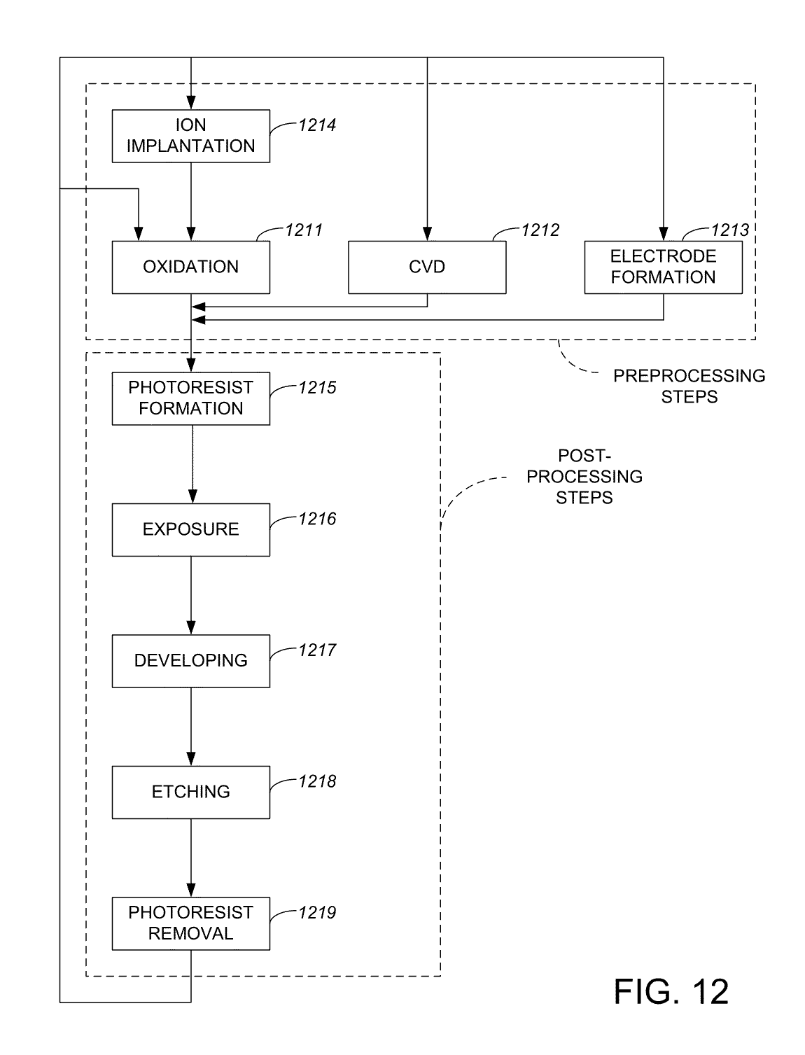

FIG. 11 is a process flow diagram which illustrates the steps associated with fabricating a semiconductor device in accordance with an embodiment of the present invention. A process 1101 of fabricating a semiconductor device begins at step 1103 in which the function and performance characteristics of a semiconductor device are designed or otherwise determined. Next, in step 1105, a reticle or mask in which has a pattern is designed based upon the design of the semiconductor device. It should be appreciated that in a substantially parallel step 1109, a wafer is typically made from a silicon material. In step 1113, the mask pattern designed in step 1105 is exposed onto the wafer fabricated in step 1109 through the use of a lithography system. One process of exposing a mask pattern onto a wafer will be described below with respect to FIG. 12. In step 1117, the semiconductor device is assembled. The assembly of the semiconductor device generally includes, but is not limited to including, wafer dicing processes, bonding processes, and packaging processes. Finally, the completed device is inspected in step 1121. Upon successful completion of the inspection in step 1121, the completed device may be considered to be ready for delivery.

FIG. 12 is a process flow diagram which illustrates the steps associated with wafer processing in the case of fabricating semiconductor devices in accordance with an embodiment of the present invention. In step 1201, the surface of a wafer is oxidized. Then, in step 1205 which is a chemical vapor deposition (CVD) step in one embodiment, an insulation film may be formed on the wafer surface. Once the insulation film is formed, then in step 1209, electrodes are formed on the wafer by vapor deposition. Then, ions may be implanted in the wafer using substantially any suitable method in step 1213. As will be appreciated by those skilled in the art, steps 1201-1213 are generally considered to be preprocessing steps for wafers during wafer processing. Further, it should be understood that selections made in each step, e.g., the concentration of various chemicals to use in forming an insulation film in step 1205, may be made based upon processing requirements.

At each stage of wafer processing, when preprocessing steps have been completed, post-processing steps may be implemented. During post-processing, initially, in step 1217, photoresist is applied to a wafer. Then, in step 1221, an exposure device may be used to transfer the circuit pattern of a reticle to a wafer.

After the circuit pattern on a reticle is transferred to a wafer, the exposed wafer is developed in step 1225. Once the exposed wafer is developed, parts other than residual photoresist, e.g., the exposed material surface, may be removed by etching in step 1229. Finally, in step 1233, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. For example, while a stage apparatus has been described as including an end effector and a linkage arrangement, a stage apparatus may instead include and end effector with no linkage arrangement, or an linkage arrangement with no end effector. That is, a stage assembly in accordance with the present invention may utilize substantially only an end effector to support tubes or substantially only a linkage arrangement to support tubes.

An apparatus or arrangement, e.g., a controller arrangement, that effectively controls the amount of current provided to coils associated with an end effector or to an actuator associated with a linkage arrangement may generally include hardware and/or software logic embodied in a tangible medium that, when executed, is operable to perform the various methods and processes described above. That is, the logic may be embodied as physical arrangements, modules, or components. A tangible medium may be substantially any suitable physical, computer-readable medium that is capable of storing logic which may be executed, e.g., by a computing system, to perform methods and functions associated with the embodiments. Such computer-readable media may include, but are not limited to including, physical storage and/or memory devices. Executable logic may include code devices, computer program code, and/or executable computer commands or instructions. Such executable logic may be executed using a processing arrangement that includes any number of processors. It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

A two-axis parallel link robot design, e.g., a driven 4-bar mechanism, may be incorporated for use as part of an overall stage apparatus. A two-axis parallel link robot may substantially minimize moving mass, and may be relatively light, fast, and stiff in an x-direction and a y-direction. As will be appreciated by those skilled in the art, such a parallel link robot may generally be used as a linkage arrangement. A tube carrier associated with a parallel link robot may be such that actuators associated with links may be substantially fixed to an inertial reference frame, and may be such that the mass of such actuators is relatively insignificant with regards to the stiffness and acceleration of the mechanism. In other words, one advantage of a parallel link robot is that the actuators of the robot motion may be fixed to an inertial reference frame, and, therefore, the mass of these actuators and possible associated gearboxes may be relatively unimportant with regards to the stiffness of a robot mechanism. As such, relatively high accelerations and a relatively high stiffness of a tube carrier stage that includes an end effector may be achieved.

It should be appreciated that in one embodiment, a moving magnet type planar motor where coils rather than magnets are located on a ground, and where magnets are located on the bottoms of a precision stage and an end effector may be used. That is, with respect to FIGS. 1A and 1B, a coil array may substantially replace magnet array 124 and one or more magnets may effectively replace coil 120 without departing from the spirit or the scope of the present invention.

The operations associated with the various methods of the present invention may vary widely. Steps may be added, removed, altered, combined, and reordered without departing from the spirit or the scope of the present invention. For example, in determining how much current to provide to coils associated with an end effector portion of a tube carrier stage, it may be determined whether the tube carrier stage is operating within a range in which the coils are active. In one embodiment, if a tube carrier stage is not operating within a range in which coils associated with an end effector portion are active, it may be determined that substantially no current is to be provided to the coils.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

1. A stage apparatus comprising:
at least one tube, the at least one tube having a first section and a second section, the first section being coupled to a point of reference;
at least one magnet;
a precision stage, the precision stage being positioned at least partially over the at least one magnet, the precision stage having a first set of coils, the first set of coils being arranged to cooperate with the at least one magnet to drive the precision stage; and
a tube carrier at least partially positioned over the at least one magnet, the tube carrier including an end effector portion arranged to carry the second section, wherein the tube carrier further includes a second set of coils, the second set of coils being supported by the end effector portion and arranged to cooperate with the at least one magnet to control motion of the end effector portion.

2. The stage apparatus of claim 1 wherein the at least one tube is at least one selected from a group including a cable and a hose.

3. The stage apparatus of claim 1 further including:
an arrangement, the arrangement being arranged to couple the end effector portion to the point of reference, wherein the point of reference is one selected from a group including a fixed point of reference and a moving point of reference.

4. The stage apparatus of claim 3 wherein the at least one magnet is an array of magnets.

5. The stage apparatus of claim 3 wherein the at least one tube includes at least one selected from a group including a cable that provides electrical power, a cable that provides electronic communications, a hose that provides compressed air, a hose that provides vacuum, and a hose that supplies a liquid.

6. The stage apparatus of claim 3 wherein the arrangement includes a linkage arrangement, the linkage arrangement being arranged to facilitate movement of the end effector with respect to at least one degree of freedom.

7. The stage apparatus of claim 6 wherein the linkage arrangement includes at least one actuator, the at least one actuator being arranged to affect movement of the end effector.

8. The stage apparatus of claim 7 wherein the linkage arrangement includes a rotational linkage and the at least one actuator is a linear motor.

9. The stage apparatus of claim 8 wherein the second set of coils cooperates with the at least one magnet to control movement of the end effector along a first axis, and the linear motor controls the movement of the end effector along a second axis.

10. The stage apparatus of claim 1 wherein the second set of coils is arranged to cooperate with the at least one magnet to control up to six degrees of freedom of movement of the end effector.

11. The stage apparatus of claim 1 wherein the second set of coils cooperates with the at least one magnet to control the end effector portion when the tube carrier operates in a first range, and wherein the second set of coils does not cooperate with the at least one magnet to control the end effector portion when the tube carrier operates in a second range.

12. An exposure apparatus comprising the stage apparatus of claim 1.

13. A wafer formed using the exposure apparatus of claim 12.

14. A stage apparatus comprising:
a precision stage arrangement;
a precision actuator, the precision actuator including a first set of coils and a magnet array, the first set of coils being coupled to the precision stage arrangement, the magnet array being coupled to a surface over which the precision stage arrangement is positioned, wherein the precision actuator is arranged to impart motion on at least the precision stage arrangement; and
an end effector arrangement, the end effector arrangement being controlled to approximately follow motion of the precision stage arrangement in at least one degree of freedom and positioned over the surface, the end effector arrangement including a second set of coils, the second set of coils being arranged to cooperate with the magnet array to control movement of the end effector arrangement.

15. The stage apparatus of claim 14 wherein the second set of coils is configured to control up to six degrees of freedom of the end effector arrangement.

16. The stage apparatus of claim 14 wherein the second set of coils includes coils arranged to provide the end effector arrangement with translational movement along an x-axis, translational movement along a y-axis, translational movement along a z-axis, rotational movement about the y-axis, and rotational movement about the z-axis.

17. The stage apparatus of claim 14 wherein the second set of coils includes coils arranged to provide the end effector arrangement with translational movement along an x-axis, translational movement along a z-axis, and rotational movement about a y-axis.

18. The stage apparatus of claim 14 wherein the end effector arrangement is configured to carry at least one tube, the at least one tube being arranged to provide at least one selected from a group including electrical power, electronic communications, compressed air, a vacuum, and a liquid.

19. The stage apparatus of claim 18 wherein the second set of coils cooperates with the magnet array to compensate for disturbances associated with the at least one tube.

20. An exposure apparatus comprising the stage apparatus of claim 14.

21. A wafer formed using the exposure apparatus of claim 20.

22. A method of operating a tube carrier that follows a precision stage in at least one degree of freedom, the tube carrier including an end effector, the end effector being arranged to carry a tube that supplies the precision stage, the tube being one selected from a group including a cable and a hose, the method comprising:
activating a precision actuator to cause movement of at least the precision stage, the precision actuator including a first set of coils mounted on the precision stage and a magnet array;
determining when the tube is associated with a disturbance to the precision stage;
determining at least one motion of the end effector to be controlled when it is determined that the tube is associated with the disturbance;
determining at least one amount of current to provide to a second set of coils mounted on the end effector to control the at least one motion of the end effector; the second set of coils being arranged to cooperate with the magnet array to control the end effector; and
providing the at least one amount of current to the second set of coils to control the at least one motion of the end effector, wherein providing the at least one amount of current to the second set of coils compensates for the disturbance.

23. The method of claim 22 wherein the disturbance is a vibration transmitted by the tube.

24. The method of claim 22 wherein the second set of coils is arranged to cooperate with the magnet array to control movement of the end effector in up to six degrees of freedom.

25. The method of claim 22 further including:
determining when the end effector is within a first range with respect to the magnet array, wherein when the end effector is within the first range, the at least one motion of the end effector to be controlled is determined, and wherein when the end effector is outside of the first range, the at least one motion of the end effector is not determined.

26. The method of claim 21 wherein the tube carrier is part of an exposure apparatus.

27. A wafer formed using the method of claim 26.

28. A stage apparatus comprising:
a precision stage arrangement;
a precision actuator, the precision actuator including a first set of coils and a first magnet array, the first magnet array being coupled to the precision stage arrangement, the first set of coils being coupled to a surface over which the precision stage arrangement is positioned, wherein the precision actuator is arranged to impart motion on at least the precision stage arrangement; and
an end effector arrangement, the end effector arrangement being controlled to approximately follow motion of the precision stage arrangement in at least one degree of freedom and positioned over the surface, the end effector arrangement including a second magnet array, the second magnet array being arranged to cooperate with the first set of coils to control movement of the end effector arrangement.
